(19) United States
(12) Patent Application Publication
(10) Pub. No.: US 2002/0169021 A1
(43) Pub. Date: Nov. 14, 2002

(54) Incremental loyalty bonusing system

(76) Inventors: Steve Urie, Reno, NV (US); Braun Martin, Auburn, CA (US)

Correspondence Address: MCANDREWS HELD & MALLOY, LTD, 500 WEST MADISON STREET, SUITE 3400, CHICAGO, IL, 60661

(21) Appl. No.: 10/133,524

(22) Filed: Apr. 26, 2002

Related U.S. Application Data
(60) Provisional application No. 60/286,747, filed on Apr. 26, 2001.
(60) Provisional application No. 60/286,497, filed on Apr. 26, 2001.

(51) Int. Cl. G06F 17/00

(52) U.S. Cl. 463/25

(57) ABSTRACT

A system and method for providing an individualized bonus to a gambling player is provided. The player may be bonused based on either initial buyin when the player contributes money to a casino account or the player may be bonused based on the buyin wager for gambling activities. The player may be bonused for wagers on electronic gaming machines or table machine. The system uses a biometric identifier for said player to determine player-specific bonusing information. The bonus percentage applied to the player may be incrementally increased as the player buyin is increased.

### RELATED APPLICATIONS

This application relates to and claims priority benefits from U.S. Provisional Patent Application No. 60/286,747 entitled “Biometric Enabled Smart Card Casino Gaming System,” filed Apr. 26, 2001 (Attorney Docket No. 13129US01), and U.S. Provisional Patent Application No. 60/286,497 entitled “Incremental Loyalty Bonusing System,” filed Apr. 26, 2001 (Attorney Docket No. 13130US01), both of which are incorporated by reference herein in their entirety.

### BACKGROUND OF THE INVENTION

Embodiments of the present invention generally relate to casino gaming systems, and more particularly to a system and method of identifying and tracking gambling activity on casino gaming systems. Most specifically, the present invention generally related to a system for providing player rewards based on a player-specific basis.

Electronic gaming machines (EGMs) have existed for decades. An EGM is a generic term for any electronic or electromechanical game that operates by chance and that rewards a player with game award credits. Typical EGMs include simulated reel slot machines, video poker, bingo, keno, blackjack and lottery. Typical EGMs are coin operated. That is, a player wishing to wager inserts a coin(s) into the EGM in order to play. Additionally, many EGMs are capable of receiving paper money in exchange for an opportunity to play.

Over the years, EGMs were developed that were capable of accepting substitutes for money. As gaming flourished, EGM operators sought to increase the efficiency of game play. For example, instead of using money to wager on an EGM, the use of credit cards was considered as a basis for activating game play. That is, a credit card could be used to insert credits into the machine. However, some laws within the United States limit, or even prohibit, the use of credit cards for paying off gaming debt. Thus, credit cards may not be a viable option for game play on an EGM due to legal restrictions.

Some gaming systems utilize casino debt cards. Typically, a player pre-pays for a debit card at the cashier's desk, or from a vending machine. The card is then inserted into an EGM, which electronically reads the amount paid for the EGM and deducts the cost of game play from the card. If a player wins, additional funds are added to the debit card. At the end of game play, the debit card is “sold” to an operator for cash.

Tickets or vouchers are also used for gaming. In this case, an EGM is wired to accept a ticket/voucher. Through a variety of methods, the monetary value of the ticket is transferred to the EGM. Unfortunately, however, the tickets/vouchers, much like cash, may be lost, stolen or destroyed. Additionally, if the EGM runs out of paper to print the tickets/vouchers, the system typically requires an attendant to insert more paper into the machine. Thus, additional time and resources are needed to maintain the ticket/voucher EGM. Also, the tickets/vouchers typically must be stored after redemption. While the ticket/voucher method may be used with EGMs, the system typically is not conducive to table games, such as blackjack or poker.

Additionally, many casinos and other gaming locations issue player cards that are used to store information regarding game play frequency. The casino typically awards, or “comps,” players for predetermined levels of play. Typically, the player cards are used in conjunction with gaming tokens or cash. That is, in order to play, a player still inserts money, tokens, or representative media into the EGM, while also inserting the player card into a separate card receptacle.

Typical electronic casino gaming carries heavy labor and capital costs. In addition to the heavy labor and capital costs, typical electronic casino gaming systems are inflexible in terms of game selection and updates. Due to the high cost of EGMs, a gaming location, such as a casino or bar operator may contract with a route operator who pays for the initial machine costs and supplies, and continuous service/maintenance in exchange for a percentage of gaming revenue.

The daily operating costs of electronic casino gaming are high, as an extensive labor force is required to handle the continuous movement of money between the EGMs, count room, and depository, for example. In some jurisdictions, jackpots over a certain amount are paid by a driver dispatched by the route operator to the location of the jackpot. Not only are employees needed to move the money, additional personnel are typically required to monitor all of the ensuing transactions. Such transactions include removing money from the EGMs, counting the money, wrapping and depositing the money, and refilling the EGMs. All of this money handling requires a heavy investment in security surveillance equipment and personnel. Additionally, personnel are typically needed to repair and service machines in the event of a coin jam or other such malfunction.

Additionally, the slot operation business is often a prime target for theft. Because of the large amounts of money that are continually moved between machine and depository, employees in charge of handling the money are often suspected, and sometimes rightfully so, of theft. Also, countless schemes by casino and bar patrons have been devised and implemented to steal money from the casino. Sometimes, the schemes to steal bear fruit.

As mentioned above, providing players with comps has been industry practice for some time in order to attract and/or retain players in order to help drive casino revenue. Indeed, since casinos first opened, dozens of variations of free play have been offered to attract and retain players. However, the greater the cash value of the promotion, the greater the exposure to player abuse becomes. For example, countless books and articles have been published on how to make money on Nevada comps and giveaways. Such books and articles typically are based on scamming casino play and food and beverage promotions. In many cases, the ability to abuse giveaway promotions or comps is a result of the casino's inability to control the use of the promotion or comp after the player receives it or the ability of a player to masquerade as another player.

Additionally, casinos are presently not able to provide promotions such as electric couponing, EGM group promotions and tracking and personalized or special group progressive jackpots, for example. Casinos are not able to provide such services because the casinos lack a system for tracking individuals and groups while the individuals and group are gaming.

Thus, a need has long been felt for a casino comp and/or rewards system that minimizes abuse by players. Specifically, a need has been felt for such a system that minimizes abuse by limiting the ability of the players to transfer comps or rewards or to masquerade as other players.

### BRIEF SUMMARY OF THE INVENTION

An embodiment of the present invention provides a system and method for providing bonus to gambling players. The bonuses are based on the total buyin of the players, that is, the amount of money that the players have contributed to their accounts as well as the amount of money that the players have wagered. Individual bonus information is kept for each player and is accessible through the use of a biometric identifier for the player. Additionally, the bonus percentage may be increased as the amount of money contributed to the player's account or wagered by the player is increased.

### BRIEF DESCRIPTION OF SEVERAL VIEWS OF THE DRAWINGS

FIG. 1 illustrates a gaming system according to an embodiment of the present invention.

FIG. 2 is a flow chart of player registration according to an embodiment of the present invention.

FIG. 3 is a flow chart of game play according to an embodiment of the present invention.

FIG. 4 illustrates a table of an exemplary embodiment of a buyin bonus.

FIG. 5 is a sequence diagram illustrating the buyin bonus system at a table game.

FIG. 6 is a sequence diagram illustrating the buyin bonus system at an electronic gaming machine (EGM).

FIG. 7 is a sequence diagram illustrating the buyin bonus system at the casino cage.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

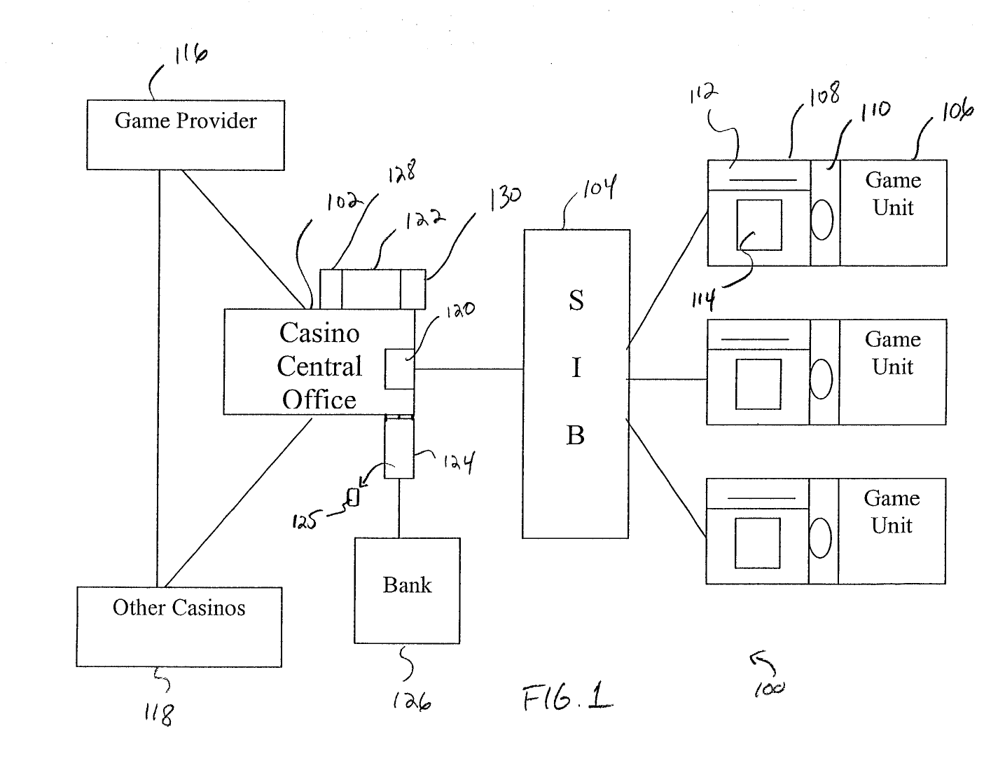

FIG. 1 illustrates a gaming system 100 according to an embodiment of the present invention. The gaming system 100 includes a casino central office 102, a system interface board (SIB) 104 electronically connected to the casino central office 102, a plurality of game units 106 having associated kiosks 108 (having central processing units) electronically connected to the SIB 104, a game provider 116, other casinos 118, or gaming centers, and a bank, or personal account center 126.

Each kiosk 108 includes a smart card, or chip card, reader (card reader) 112, a biometric reader 110 and a display 114. The casino central office 102 includes at least one secured server 120, an authorization unit 122, and a chip card distribution system 124, which is electronically connected to the bank 126. The authorization unit 122 includes an authorization biometric reader 128 and an input device 130. The authorization unit 122 is electronically connected to the server 120 and the chip card distribution system 124. Further, the casino central office 102, in general, may be networked to the bank 126, or the bank 126 may be part of the casino central office 102. Additionally, the casino central office 102 is networked to the game provider 106 and other casinos 118. Additionally, the casino central office 102 is networked to the game units 106 and kiosks 108 through the SIB 104. The SIB may be used to convert an electronic communications protocol into another electronic communications protocol. For example, when the gaming system 100 in installed in a legacy gaming system and the game units 106 use a different communications protocol from the gaming system 100. Alternatively, the SIB may not be included in the system if there is no need to convert communications protocols. For example, if the game units 106 are installed as part of the gaming system 100 and have been designed to be compliant.

Each game unit 106 includes a central processing unit that communicates with the central processing unit of the kiosk 108 associated with the game unit 106. The game units 106 may provide at least one of a bingo, keno, table game, blackjack, video poker, or other such casino game. If the game unit 106 is a table game, such as blackjack or poker, the dealer may input information on a computer having a central processing unit, which may communicate with the kiosk 108, and ultimately the casino central office 102. Because the casino central office 102 is networked to the game provider 116, the game provider 116 may update game selection on the game units 106 at predetermined times. For example, the game provider 116 may update a video poker game on a game unit 106 to a new version of the video poker game. Alternatively, the game provider 116 may substitute video poker on a game unit 106 for video slots. The casino central office 102 may request changes from the game provider 116, or the game provider 116 may unilaterally update or change games on the game units 106. Also, the casino central office 102 may change games on the game units 106. Further, the casino central office 102 may include a stored library of games that may be electronically sent to the game units 106. Additionally, a plurality of games may be programmed into each game unit 106. That is, each game unit 106 may allow a player to select from a plurality of casino games.

In order to begin play within the gaming system 100, a player first registers. A player may register at the casino central office 102, or at any other location that is networked into the casino central office 102. That is, a player may register at the authorization unit 122 of the central office 102, or any other location, which is networked to the gaming system 100, that enables a player to input personal information, such as name, address, etc., and biometric information, such as a unique biometric identifier.

Registration requires a player to input biometric data into the authorization unit 122. The authorization unit 122 registers the individual's biometric identifier, such as a fingerprint, via an authorization biometric reader 128. That is, an individual presents a biometric identifier to the authorizing biometric reader 128. Then, the authorization biometric reader 128 scans the individual's biometric identifier, such as a fingerprint, and captures various points of identification from the biometric identifier. That is, the authorization biometric reader 128 scans the biometric identifier and extracts the biometric indicators from the biometric identifier. The authorization biometric reader 128 subjects the biometric indicators to a recognition algorithm that converts the scanned biometric identifier image into a much smaller data code. The authorization biometric reader 128 then sends the smaller data code of biometric identification, or biometric data, to an authorizing storage unit within the authorization unit 122.

Next, a casino desk attendant (or the player) may input personal information such as name and address via the input device 130. The input device 130 may be a computer keyboard or touch-sensitive monitor, for example. The personal information is then sent to the authorizing storage unit within the authorization unit 122. An encoder then receives the biometric data and the personal information from the authorizing storage unit. The personal information and the biometric data may then be encoded. That is, the encoder may then match and combine the personal information with the biometric data. The encoded personal information and biometric data are then stored within the casino central office 102 as tracking information within the server 120, or within another data storage unit capable of storing large numbers of such data. Once the personal information and biometric data have been matched and combined, registration is complete.

Additionally, the player may also set up an account with the casino. That is, the player may deposit an amount with the casino, which is then electronically transferred to the bank 126. The player may then be issued an account chip card 125 by the chip card distribution system 124. A chip card, or smart card, is a plastic card similar to a credit card that has an embedded microprocessor chip, having a memory (for example 256K of memory), which allows for the encryption of transmitted data. The chip card may be used to access a player's account at the bank 126. Alternatively, the account chip card 125 may be used to access a player's own personal bank account. That is, while the casino central office 102 may have, or be networked with, a casino bank 126, the casino central office 102 may also be networked with financial institutions around the world. Thus, a player may be able to directly access personal finances at the player's personal financial institution through the account chip card 125.

The account chip card 125 issued to the player is linked, or associated, with the player's biometric data. That is, preferably, the account chip card stores the player's biometric data. The chip card distribution system 124 requires a player, or casino operator, to input a player's personal information, which is then associated with the account chip card 125. The personal information is then cross-linked to the biometric data of the player. That is, a player wishing to use the account chip card 125 may be required to input biometric data to extract funds from his account. Because the account chip card 125 may be associated with a player's biometric data, only the player may extract funds from the account chip card 125. In other words, if a thief tries to use the player's account chip card 125, the thief will not be granted access to the player's account because in order to use the account chip card 125, a kiosk 108 may require biometric data to activate the account chip card 125. The biometric data input into the kiosk 108 must match the biometric data associated with the account chip card 125. Alternatively, because the biometric data may be stored on the account chip card 125, the kiosk 108 may perform an initial comparison between the biometric data on the account chip card 125 and the biometric data input at the game biometric reader 110. Also, The account chip card 125 may store accrued comp points. Thus, the account chip card 125 and a player's biometric data (stored in conjunction with a player's personal information as tracking information), such as a fingerprint, may be used to provide an efficient, safe and streamlined way of gaming. Alternatively, accrued comp points may be associated with a player's biometric identifiers and may be stored at the central office 102 or on the server 120.

Preferably, unlike magstripe cards, which can store only 384 bytes of data (data that may be easily read or altered) the account chip card 125 is a smart card of the type which currently may store up to 256 kilobytes of memory, and are encrypted with a high level of security

The tracking information may be used to track player activity. For example, the tracking information may track the number of times the player has played. The tracking information, therefore, may be used to award a player comps, such as free drinks, meals, hotel stays, vacations, etc., based on the number of times a player plays. That is, the tracking information, whether stored on the account chip card 125 or on the server 120, keeps a running tally of comp points, which may be redeemed for comps or rewards.

Once the player is registered, the player may begin a gaming session. A player either inserts cash into the came unit 106, or inserts an account chip card 125 into the card reader 112. Either way, the display unit 114 then prompts the player to provide a biometric identifier to the game biometric reader 110. Alternatively, as mentioned above, the account chip card 125 may be inserted into the card reader 112. The player may then input biometric data into the game biometric reader 110. The kiosk 108 may then compare the input biometric data with that stored on the account chip card 125. If the player is using cash and does not want to be “tracked,” (or if the player never registered), the player may opt to not provide a biometric identifier to the game biometric reader 110. That is, the kiosk 108 may include a bypass mechanism (such as a button, or touchscreen), which allows the player to bypass comp accrual (that is, storing game play points for frequency of play within the player's tracking information) and/or streamlined methods of paying for game play.

However, if the player wants to accrue game play points (comp points), the player provides biometric data, such as a fingerprint, to the game biometric reader 110. The game biometric reader 110 scans the biometric identifier. The game biometric reader 110 subjects the biometric indicators of the biometric identifier to a recognition algorithm that converts the scanned biometric identifier image into a much smaller data code. The game biometric reader 110 then sends the smaller data code of biometric identification, or biometric data, to a storage unit within the kiosk 108. The kiosk 108 then communicates with the server 120 at the casino central office 102. The server 120 searches for matching biometric data stored within the server 120 or elsewhere in the computer system of the casino central office 102. The server 120 then communicates with the kiosk 108 as to the identity of the player. If a match between the biometric data input at the game biometric reader 110 and the biometric data stored in the casino central office exists, the display 114 on the kiosk 108 may display the player's name and the player's comp points. If no match exists, the display 108 may display an appropriate message informing the player that there are no records for the player. Alternatively, as mentioned above, if an account chip card 125 is used, the kiosk 108 may perform a local comparison between the biometric data input at the kiosk 108, and the biometric data stored on the account chip card 125. Then, if a match exists, the kiosk 108 may retrieve account and/or comp point information from the server 120.

Once a match has been confirmed, the player may begin to wager on the game unit 106 (and subsequently play the selected game). A predetermined number of comp points may be associated with each wager. In one embodiment, a player may be required to provide a biometric identifier with each wager. Alternatively, the player may input biometric data once in a gaming session, and then engage a discontinue button on the kiosk 108 when the player is finished with the gaming session. Also, alternatively, the kiosk 108 may terminate a player's gaming session after a predetermined period of inactivity. The kiosk 108 may transmit the accrued amount of comp points to the casino central office 102 each time a player wagers, or the kiosk 108 may store the accrued amount of comp points for a particular length of time within the central processing unit of the kiosk 108. Then, the kiosk 108 may transmit the total number of accrued comp points within a gaming session at predetermined times, or when the player is finished gaming on the associated game unit 106.

The player may redeem comp points at stations within the casino. For example, the casino may include biometric readers within restaurants, or bars, within the casino. The player may input biometric data at the biometric readers to pay for food, beverages, etc. Also, the player may input biometric data at the casino central office 102 to view the total amount of comp points accrued in order to find out if the player has accrued enough points for various other comps, such as free hotel stays or vacations to Las Vegas or Monte Carlo, for example. Thus, the use of biometric data and information replaces the use of magnetic cards for tracking player game play frequency and comp points. Because the player does not need a magnetic card to store tracking information and comp points, the player need not worry about losing the card. Consequently, keeping track of player game play frequency and comp points is more efficient.

As mentioned above, a player may also opt to use an account chip card as a substitute for cash, and as medium for storing accrued comp points. Because the account chip card is associated with the player's biometric data, theft of the account chip card will only result in theft of an amount equal to the card itself. If a player loses the account chip card 125, the player may notify the casino, which may retrieve the player's account and comp information (and subsequently issue the player a new card with the player's account and comp information).

Each time a player plays a game on a game unit 106, the player may use the chip card as a substitute for cash to play. In other words, because the game unit 106 and kiosks 108 are linked to the casino central office 102, funds may be extracted from a player's account at the bank 126 (or personal financial institution) upon game play. For example, as discussed below, if a player wishes to play video poker on a game unit 106, the player inserts the account chip card 125 into the card reader 112. The player then authorizes debits from the account (located at the bank 126 or personal financial institution) through biometric data. If the biometric data and information on the account chip card 125 and that stored in the server 120 of the casino central office 102 match, the game unit 106 communicates with the bank 126 (or personal institution) to debit the player's account for the cost of a game of video poker. If the player wins, a corresponding amount of winnings is credited to the account located at either the bank 126 or the player's personal financial institution. A player may be required to provide a biometric identifier with each wager. Alternatively, the player may input biometric data once in a gaming session, and then engage a discontinue button on the kiosk 108 when the player is finished. Also, alternatively, the kiosk 108 may terminate a player's gaming session after a predetermined period of inactivity.

If, however, the biometric data input at the game biometric reader 110 and the biometric data stored within the server 120 do not match, the player is not allowed to use the account chip card 125 as a way of paying for game play. Also, if a match does not exist, the server 120 may alert an electronic security post within the casino central office 102 that the player playing at the location of the game unit 106 is attempting to play with an account chip card that is not authorized for use by the player. Thus, the gaming system 100 provides a safer and more efficient way of paying for game play.

Alternatively, the biometric data of a player alone may be used to access a player's account. That is, instead of using the account chip card 125, the gaming system 100 may be configured such that a player's biometric data permits a player to gain access to the player's account. The kiosk 108 may prompt the player to choose a method of payment. The player may choose to debit an account at the bank 126, or the player's personal financial institution. In other words, during registration, the player may set up an account that is associated with the player's biometric data, thereby eliminating the need for a separate account chip card.

For example, the play may proceed through the registration process much as discussed above by registering a biometric identifier at the central office 120. However, at the central office, the player may set up an account or make a deposit that is associated not with a smart card, but directly with the payer's biometric identifier. The player may then proceed to any game unit 106 and gain access to the game unit 106 via the biometric reader on the game unit 106. The game unit 106 sends the player's biometric data to the central office 120 and retrieves the player's account information including, for example, an account balance a comp or rewards balance, and a personal jackpot balance. As the player plays at the game unit 106, the updated balance and comp information may be relayed to the central office 120 for storage. In this fashion, the player is afforded great freedom around the casino and worries regarding the loss of smart cards are eliminated, as well as the cost of issuing smart cards and installing smart card systems.

Although the system of FIG. 1 has been described in terms of employing a biometric reader to perform positive identification. Any method of performing a positive identification may be substituted. For example, a positive identification may be obtained through the use of an encrypted smart card instead of through a biometric.

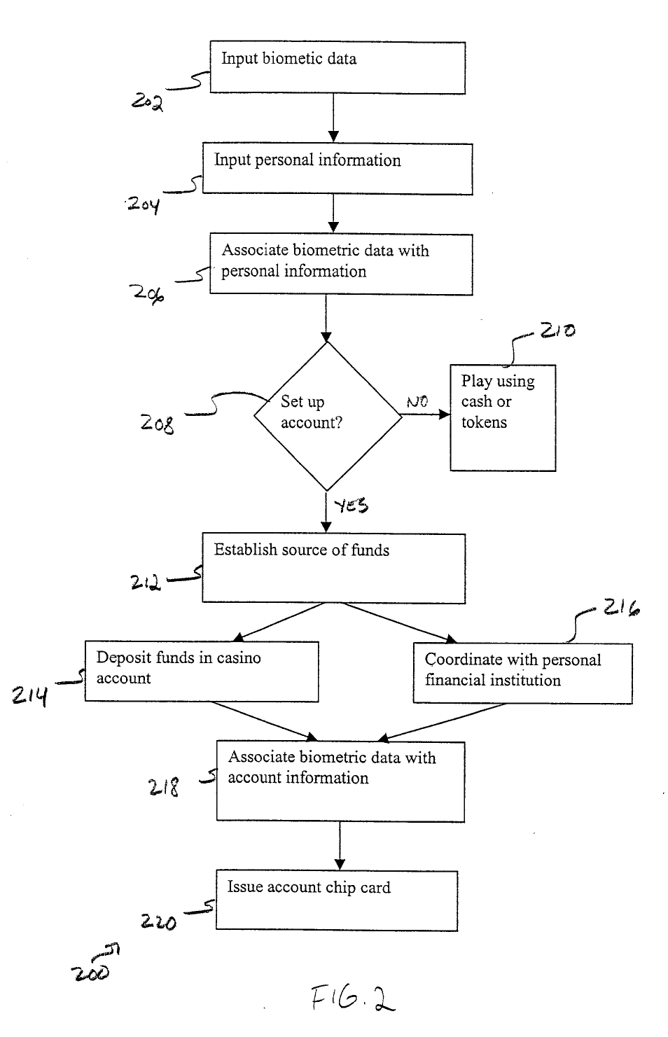

FIG. 2 is a flow chart 200 of player registration according to an embodiment of the present invention. At 202, a player inputs biometric idea at an authorization unit. The player, or a casino operator, also inputs personal information, including name, address, social security number, etc. at step 204. At 206, the authorization unit associates the player's personal information and biometric data with one another. At 208, the player has an option to set up an account. If the player does not want to set up an account, the player may begin game play using cash or tokens at 210, while the player's biometric data may be used for tracking purposes, such as comp points. If, however, the player does wish to set up an account, the player may establish a source of funds at 212. The player may deposit fund in the casino's account at 214, or the player may coordinate with his personal financial institution at 216 such that he may draw directly from the institution. Either way, at 218, the casino central office associates the player's biometric data with the account information. Finally, at 220, an account chip card is issued to the player. The account chip card may be used for drawing from the player's account for gaming purposes (with winnings being credited to the account) and/or tracking of comp points. Either way, the account chip card must be used in conjunction with biometric data.

Similar to the system of FIG. 1, the flowchart of FIG. 2 has been described in terms of using a biometric to provide a positive identification of the player. However, any methodology of providing a positive identification of the player may alternately be applied. For example, an encrypted smart card may be employed to provide a positive identification of the player.

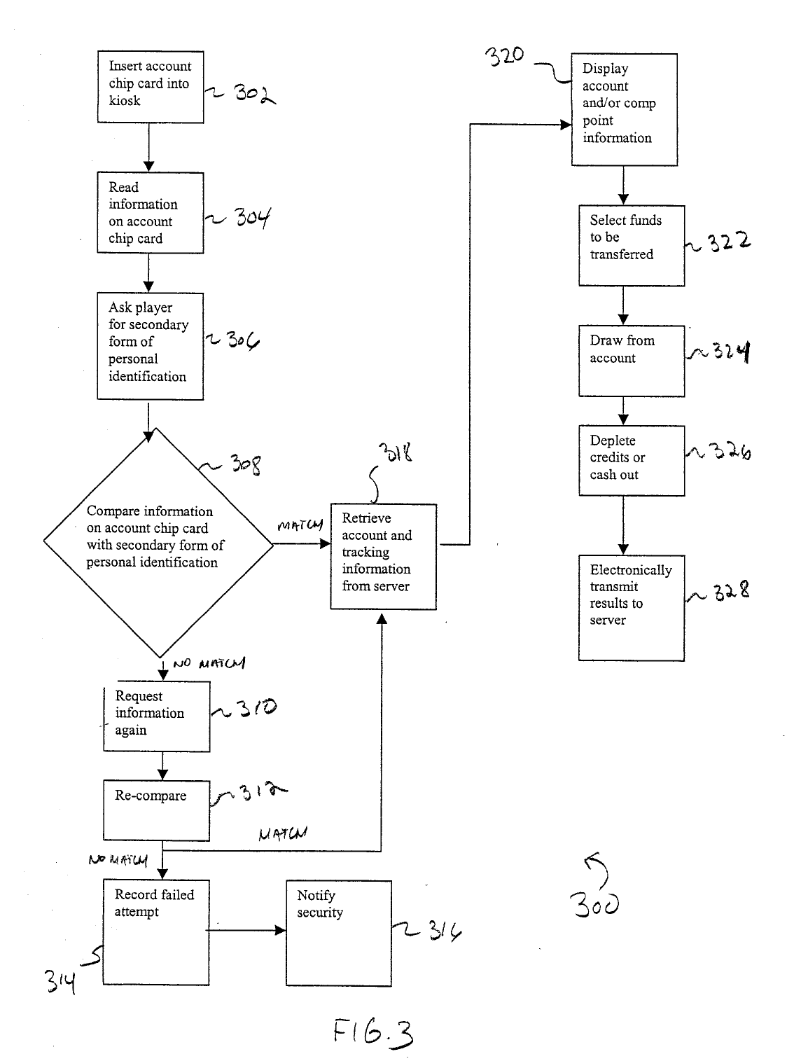

FIG. 3 is a flow chart 300 of game play according to an embodiment of the present invention. At 302, a player inserts an account chip card into a kiosk that is associated with a game unit.

Alternatively, the player may input biometric data, which is then compared to tracking and account information stored on the server. That is, because tracking information, including biometric data, personal information, comp points, etc. and account information may be stored on the server in the casino central office, the player may access the tracking information and account information through biometric data alone (as opposed to biometric data and the account chip card).

If, however, the account chip card is used, at 304, the kiosk reads information on the account chip card. The kiosk, at 306, asks, or prompts, the player for a secondary form of personal identification, such as a biometric identifier. The kiosk then compares the biometric data on the account chip with the secondary form of personal identification entered at the kiosk at 308.

Alternatively, as discussed above, the kiosk may bypass this step and forward the biometric data, that is the secondary form of identification, to the server. The server may then compare the secondary form of identification with the biometric data of the tracking information stored in the server. The server may then forward the results of the comparison to the kiosk.

If, however, the account chip card is used and the kiosk performs a local comparison, the kiosk determines if a match exists. If a match does not exist, the kiosk requests the secondary form of identification again at 310. At 312, the kiosk re-compares the secondary form of identification with the biometric data stored on the account chip card. If a match still does not exist, the kiosk records the failed attempt with the server at 314. Additionally, the server and/or the kiosk alerts security as to the failed attempt at 316.

On the other hand, if a match does exist, the kiosk retrieves account and tracking information from the server at 318. The kiosk displays the retrieved account and/or comp point information at 320. At 322, the player then selects the funds to be transferred to the kiosk. That is, the player decides how much to wager. At 324, a corresponding amount of funds are drawn from the player's account. At 326, the player continues to play until credits are depleted, or until the player decides to cash out. At 328, the kiosk electronically transmits the results of the gaming session to the server. The results may be transmitted after each round or hand, or at the end of the player's gaming session. The player may then redeem comp points by inserting the account chip card and/or inputting biometric data at appropriate terminals.

Additionally, as mentioned above, a need has long been felt for a casino comp and/or rewards system that minimizes abuse by players, for example, by limiting the ability of the players to transfer comps or rewards or to masquerade as other players. Because the present system uses a player-specific biometric identifier, a casino is able to accurately target comps to a specific player without the ability of players to abuse the system.

One system of providing comps or rewards to players is a player-specific system such as a biometrically enabled smart card system is to provide players with a buyin bonus. The buyin bonus offers casinos the opportunity to give earned cash bonuses at the time of game buyin. The time of buyin may be the time at which a player first transfers fund to their account in order to begin playing. Alternatively, the time of game buyin may be the point at which a player has gained access to a game unit 106 and indicated the amount of the wager. The amount of the wager is the game buyin. Because the player has already been verified by their biometric information, the buyin bonus comp or reward is free from the threat of player abuse, unlike today's coupons and players club points systems.

For example, at the time of buyin players may be given a bonus or reward (a percentage of the buyin amount) that may be played like cash at the game unit 106. The bonus may take the form of a percentage of the buyin amount. Over time, the percentage of the buyin amount that is awarded to the player as a bonus may be increased. For example, a player may be given $102 of credit for casino play for every $100 of cash buyin when they first signup for their smart card. After $40,000 of play, the bonus may be increased to $103.00 of credit for $100 of buyin, and after $100,000 of play, the bonus may again be increased to $104 of credit for $100 of buyin.

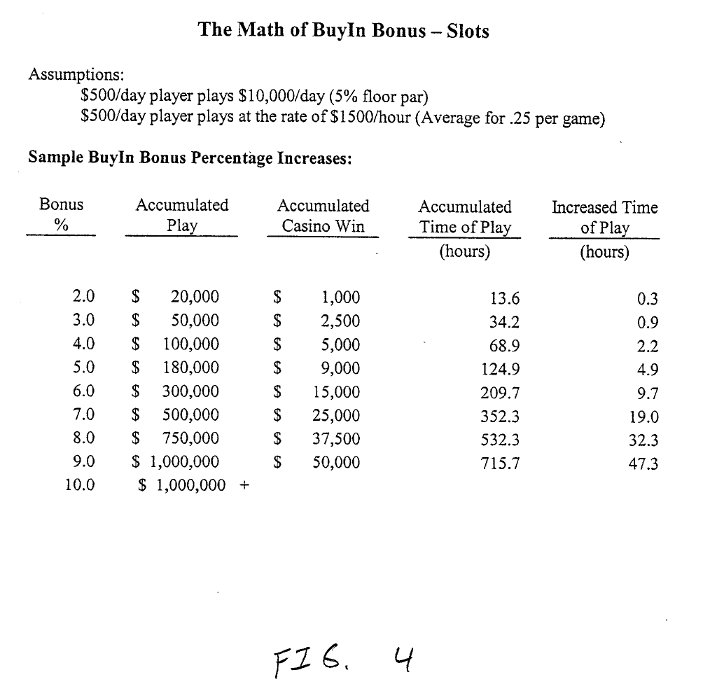

FIG. 4 illustrates a table of an exemplary embodiment of a buyin bonus. As shown in FIG. 4, the table assumes the a $500 per day player plays $10,000/day worth of games. That is, a player buys in for $500 per day and then plays games so that the total amount of money that is wagered by the player over the course of the day (as the player wins and loses) is $10,000. Typically, an average statistical lose per wager for the player is 5%. That is, regardless of whether the player wins or loses in any given wager, statistically, each wager returns only 95% of the wagered amount. Additionally, it is assumed that the player make wagers at the rate of $1500 worth of wagers per hour.

Employing the above assumptions, an embodiment of an incremental reward system employing a buyin bonus is shown. In FIG. 4, the buyin bonus begins at 2% and rises incrementally to 10% based on the total buyin of the player. The “accumulated play” column represents the total of all wagers made by the player or the total buyin. The “accumulated casino win” is based on the average statistical loss per wager of 5%. That is, if a player makes wagers totaling $20,000, statistically the casino has cleared or obtained 5% of $1,000.

The column entitled “accumulated time of play” represents the total time of play that the player will have if the player plays at a rate of $1500 per hour. The “accumulated time of play” represents the time of play due to the initial buyin as well as the additional time of play that arises due to the buyin bonus. The “increased time of play” is the portion of the “accumulated time of play” that is due to the buyin bonus. For example, taking “accumulated play” of $50,000 and dividing by the player play rate of $1500 per hour yields 33.3 hours. Adding the “increase time of play” due to the buyin bonus of 0.9 hours yields 34.2 hours of “accumulated time of play.”

Theoretically, a player may reach a high bonus percentage, buyin at a bonus percentage higher than the win percentage of the game, play the amount of buyin and bonus, and then cash out at a profit. However, the BuyIn Bonus Loyalty system allows the casino operator to control this type of player transaction. For example, the casino operator may only allow the player to cash out at a predetermined level and/or frequency. For example, after reaching the 10% bonus level, a player could buyin for $1000, receive a $100 bonus, play the $1100 on a 3.0% hold game, and cash out at $1070 (on average) with a $70 profit. Yet, by the time the player has reached the 10% bonus level, the casino has already won, on average, $50,000 from the player. The BuyIn Bonus system may monitor this method of arbitrage and may be configured to stop bonusing the player within parameters set by the casino operator. For example, if a player cash out would result in a loss to the casino, the play may be prevented from cashing out.

At first glance, it may appear to a player that the operator is slowly giving away the casino, which is a good perception to give to incentivise additional wagering. However, the player preferably must play all of the buyin and bonus before receiving another bonus and the player is incentived to reach ever higher levels of bonusing by playing. Thus, the “time of play to loss” is increased but the “win percentage to play” remains the same. The operator, of course, is not giving away the casino, but the player truly receives greater value because their time at the game is increased, and the more they play, the more their loyalty is rewarded.

An additional benefit of the BuyIn Bonus to the casino is player retention. For example, when a player reaches higher percentage levels of bonusing, the player loyalty may be increased because the player would have to abandon bonusing in order to wager elsewhere. That is, there is no incentive to go to another casino where the player would have to start at the lowest bonusing percentage level, that is, if bonusing even existed at the other casino.

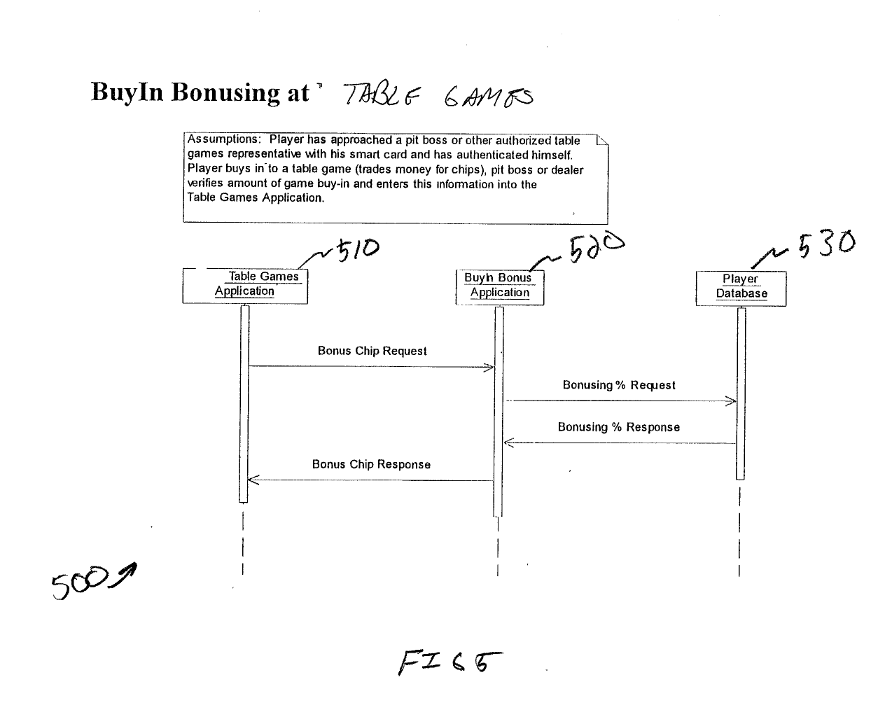

FIG. 5 is a sequence diagram 500 illustrating the buyin bonus system at a table game. The diagram 500 includes a table games application 510, a buyin bonus application 520, and a player database 530. The diagram 500 represents an exemplary case in which the player has approached a pit boss or other authorized table games representative with a smart card and the player has been authenticated. The player buys into a table game (for example, by trading money for chips), the pit boss or dealer verifies the amount of the game buy-in and enters this into the table games application. The table games system 510 then initiates a bonus chips request. The table games application 510 sends a message to the buyin bonus application 520 requesting the number of additional “bonus” chips to give the player in addition to his buy-in chips. The buyin bonus application 520 then initiates a bonusing percent request. That is, the buyin bonus application 520 requests this player's current buyin bonusing percentage (the amount of bonus the casino currently gives this player at buyin) from the player database 530. The buyin bonus application may also request information about player's play history including total accumulated play, play since last buyin bonus awarded, and amount of last game buy-in and bonus. This information may be displayed to the dealer and/or the player. The player database 530 retrieves the information regarding the player's bonusing request and sends a bonusing percent response to the buyin bonus application 520. The buyin bonus application 520 determines the number of additional “bonus” chips (if any) to be given to the player for his buy-in. The buyin bonus application 520 then sends a bonus chip response to the table games application 510. The table games application 510 may then display this information for the dealer or pit boss to see and verify.

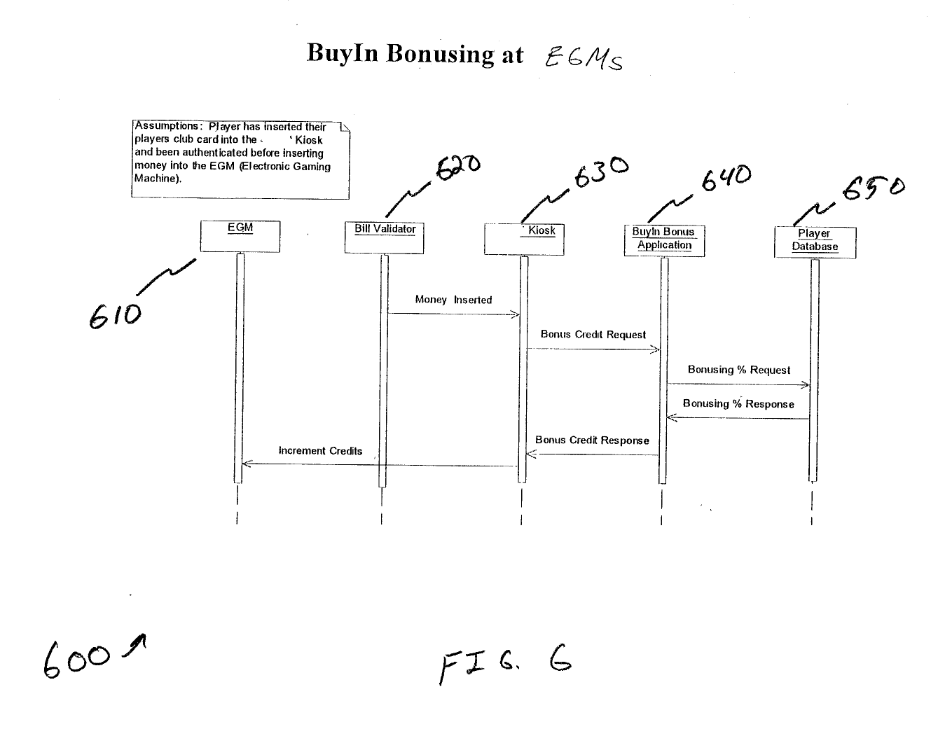

FIG. 6 is a sequence diagram 600 illustrating the buyin bonus system at an electronic gaming machine (EGM). The diagram 600 includes an EGM 610, a bill validator 620, a kiosk 630, a buyin bonus application 640, and a player database 650. The diagram 500 represents an exemplary case in which a player has inserted their card into the kiosk and has been authenticated before inserting money into the EGM 610. First, money is inserted into the bill validator 620. The kiosk 630 intercepts the message from the bill validator 620 to the EGM 610 regarding the denomination of bill that has been inserted into the bill validator 620. The kiosk 630 then sends a bonus credit request to the buyin bonus application 640 requesting the number of additional “bonus” credits should be added to the credit meter of the player's machine. The buyin bonus application 640 then requests the player's current buyin bonusing percentage (the amount of bonus the casino currently gives this player at buyin) from the player database 650. The buyin bonus application 640 also requests information about the player's play history including the total accumulated play, the play since last buyin bonus awarded, and amount of last game buy-in and bonus, for example. The player database 650 responds to buyin bonus application 640 the bonusing percent request with the appropriate bonus percentage. The buyin bonus application 640 then determines the number of additional “bonus” credits to be given to the player (if any) and forwards, the number of bonus credits to the kiosk 630. The kiosk 630 then increments the EGM credit meter with the appropriate credits for the denomination of bill inserted plus additional bonus credits (if any).

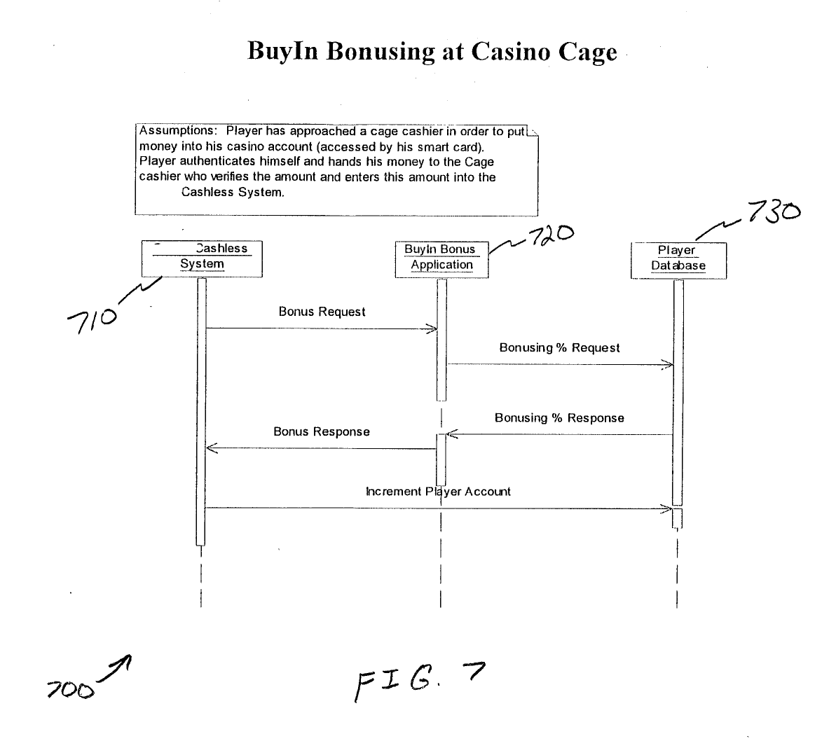

FIG. 7 is a sequence diagram 700 illustrating the buyin bonus system at the casino cage. The diagram 700 includes a cashless system 710, a buyin bonus application 720, and a player database 730. The diagram 700 represents an exemplary case in which a player has approaches a cage cashier in order to put money into a casino account accessed by the player's smart card. The player is authenticated and provides cash to the cage cashier. The cage cashier then verifies the amount of the cash and enters the amount into the cashless system. In operation, the cashless system 710 sends a message to the buyin bonus application 720 requesting the number of additional “bonus” dollars (and percentages of dollars) to add to this player's account based on the player's current deposit into their player account. The buyin bonus application 720 then requests the player's current buyin bonusing percentage (the amount of bonus the casino currently gives this player at buyin) from the player database 730. The buyin bonus application 720 also requests information about the player's play history including, for example, total accumulated play, play since last buyin bonus awarded, and amount of last game buy-in and bonus. The player database then responds to bonusing percent request by sending the applicable bonusing percent to the buyin bonus application 720. The buyin bonus application 720 then determines the number of additional “bonus” dollars and cents (if any) to be included in the player's current deposit into their player account. The buyin bonus application 720 then sends a bonus response to the cashless system 710 to display the new account balance for the cashier and/or player. The cashless system 710 then instructs the player database to increment the player's casino account by the deposit amount plus any additional “bonus” amount awarded by the buyin bonus application 720.

Additionally, present biometrically-enabled system allows electric couponing. That is, additional bonus or promotions may be electronically delivered to a player account.

Additionally, the present biometrically-enabled system allows EGM group promotions. For example, a group such as the group members of a particular convention may participate in a slot tournament only among the group members, even while non-members are playing at nearby slots. The members of the group may be electronically tracked and the results of the slot tournament shared among members.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for providing individualized rewards, said system including:
an access reader retrieving a user-specific identifier from a user and transmitting said user-specific identifier to a user database; and
a user database receiving said user-specific identifier and utilizing said user-specific identifier to access stored user information, said database determining reward information for said user based in part on said user-specific information and providing said reward information to said user.

2. The system of claim 1 wherein said user-specific identifier is a biometric identifier.

3. The system of claim 1 wherein said user-specific identifier is a smart card.

4. The system of claim 1 further including a bonus application rewarding said user by crediting said reward to an account accessible by said user.

5. The system of claim 4 wherein said access reader is included as part of an electronic gaming device.

6. The system of claim 5 wherein said user is rewarded when the user deposits monetary credits into said electronic gaming device.

7. The system of claim 5 wherein said user is rewarded when the user places a wager on said electronic gaming device.

8. The system of claim 5 wherein said reward is incrementally increased based on the total amount that the user has wagered.

9. A system for providing an individualized bonus to a player, said system including:
an biometric reader determining a biometric characteristic of a player and transmitting a biometric identifier based on said biometric characteristic to a bonusing application;
a bonusing application receiving said biometric identifier from said biometric reader and transmitting said biometric identifier to a player database; and
a player database including bonus information specific to said player, said player database transmitting said bonus information to said bonusing application in response to said biometric identifier.

10. The system of claim 9 further including a smart card reader for accepting a smart card from said player.

11. The system of claim 9 wherein said bonusing application determines a bonus for said player based in part on said bonus information.

12. The system of claim 11 wherein said bonusing application credits said bonus to an account accessible by said player.

13. The system of claim 12 wherein said biometric reader is included as part of an electronic gaming device.

14. The system of claim 13 wherein said player deposits a monetary credit into said electronic gaming device and said bonus is credited to said player based on a percentage of said monetary credit.

15. The system of claim 12 wherein said player wagers a monetary credit on said electronic gaming device and said bonus is credited to said player based on a percentage of said wager.

16. The system of claim 15 wherein said bonus is incrementally increased based on the total amount that the player has wagered.

17. A gambling system providing a bonus to an account accessible by a player, said system including:
an identity verification device determining identifying information for said player;
a bonus requesting device transmitting said identifying information to a bonus database;
a bonus database with bonus information specific to said player, said database transmitting said bonus information to a bonus determination device;
a bonus determination device determining a bonus based in part on said bonus information and transmitting said bonus to a bonus creditor; and
a bonus creditor for crediting said bonus to an account accessible by said player.

18. The system of claim 17 further including a monetary credit receiving device and wherein said player deposits a monetary credit into said monetary credit device and said bonus is credited to said player based on a percentage of said monetary credit.

19. The system of claim 17 wherein said player wagers a monetary credit on said gambling system and said bonus is credited to said player based on a percentage of said wager.

20. The system of claim 19 wherein said bonus is incrementally increased based on the total amount that the player has wagered.
